(19) United States
(12) Patent Application Publication
(10) Pub. No.: US 2025/0016593 A1
(43) Pub. Date: Jan. 9, 2025

(54) METHODS AND APPARATUSES FOR MULTI-RESOLUTION CSI FEEDBACK FOR WIRELESS SYSTEMS

(71) Applicant: InterDigital Patent Holdings, Inc., Wilmington, DE (US)

(72) Inventors: Yugeswar Deenoo Narayanan Thangaraj, Chalfont, PA (US); Moon IL LEE, Melville, NY (US); Arnab Roy, Phoenixville, PA (US); Mohamed Salah Ibrahim, Chesterbrook, PA (US); Arman Shojaeifard, London (GB); Ghyslain Pelletier, Montreal (CA); Onur Sahin, London (GB)

(21) Appl. No.: 18/706,255

(22) PCT Filed: Nov. 2, 2022
(86) PCT No.: PCT/US2022/048672

§ 371 Date: Apr. 30, 2024

Related U.S. Application Data
(60) Provisional application No. 63/275,180, filed on Nov. 3, 2021.

(51) Int. Cl. H04W 24/10; H04B 7/0456; H04B 7/06

(52) U.S. Cl. CPC H04W 24/10; H04B 7/0456; H04B 7/0626

(57) ABSTRACT

Procedures, methods, architectures, apparatuses, systems, devices, and computer program products includes measuring Channel State Information (CSI) associated with at least one reference signal and determining a trained Artificial Intelligence (AI) model to generate at least a portion of a report that includes the CSI associated with the at least one reference signal. The report comprising the CSI associated with the at least one reference signal is transmitted.

### CROSS-REFERENCE TO RELATED APPLICATIONS

This application claims the benefit of U.S. Patent Application No. 63/275,180, filed Nov. 3, 2021, which is incorporated herein by reference in its entirety.

### BACKGROUND

This disclosure pertains to methods and apparatus for performing wireless communications. For example, methods and apparatus for supporting multi-resolution Channel State Information (CSI) feedback are disclosed.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates an example of CSI measurement setting according to the present disclosure;

FIG. 3 depicts an example of codebook-based precoding with feedback information;

FIG. 4 illustrates an example of a method for multi-resolution CSI feedback for a wireless system;

FIG. 5 is a flowchart illustrating a representative method for supporting multi-resolution CSI feedback implemented by a WTRU;

FIG. 6 is a flowchart illustrating another representative method for supporting multi-resolution CSI feedback implemented by a WTRU; and

FIG. 7 is a flowchart illustrating another representative method of pairing implemented by a WTRU.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

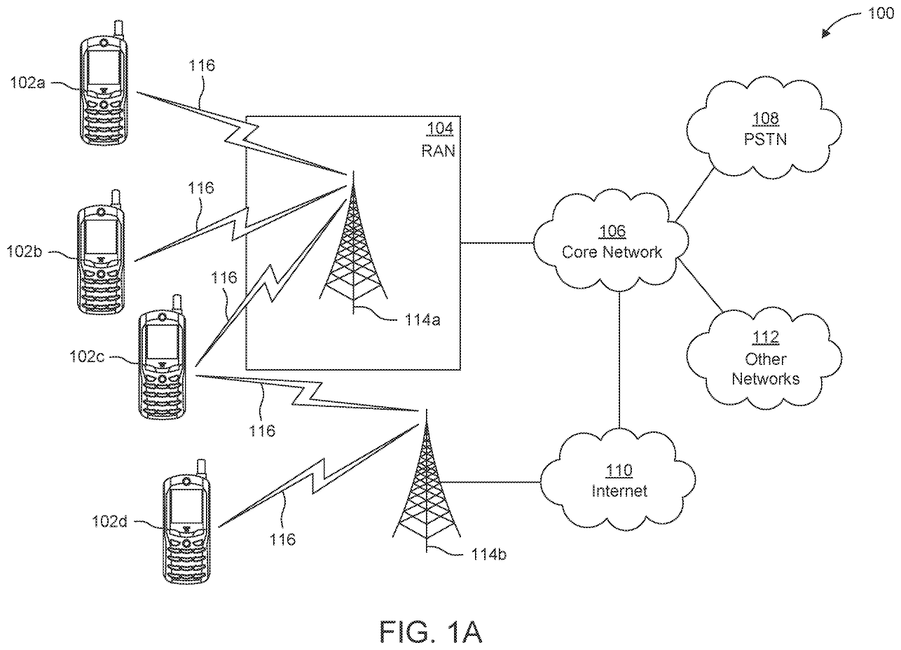

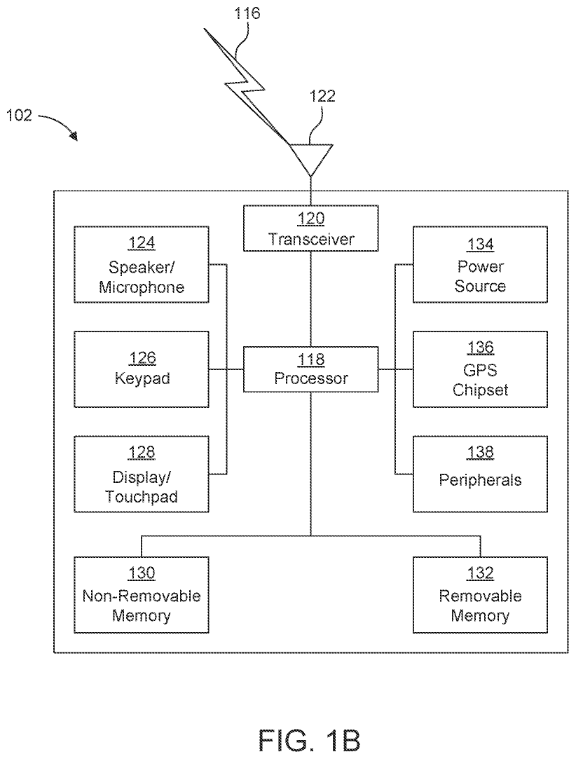

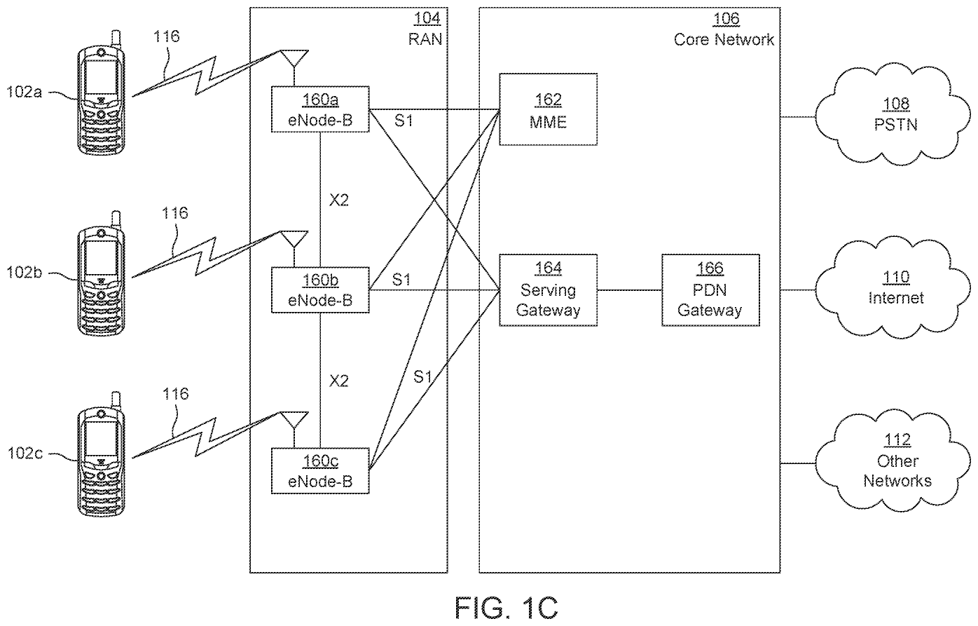

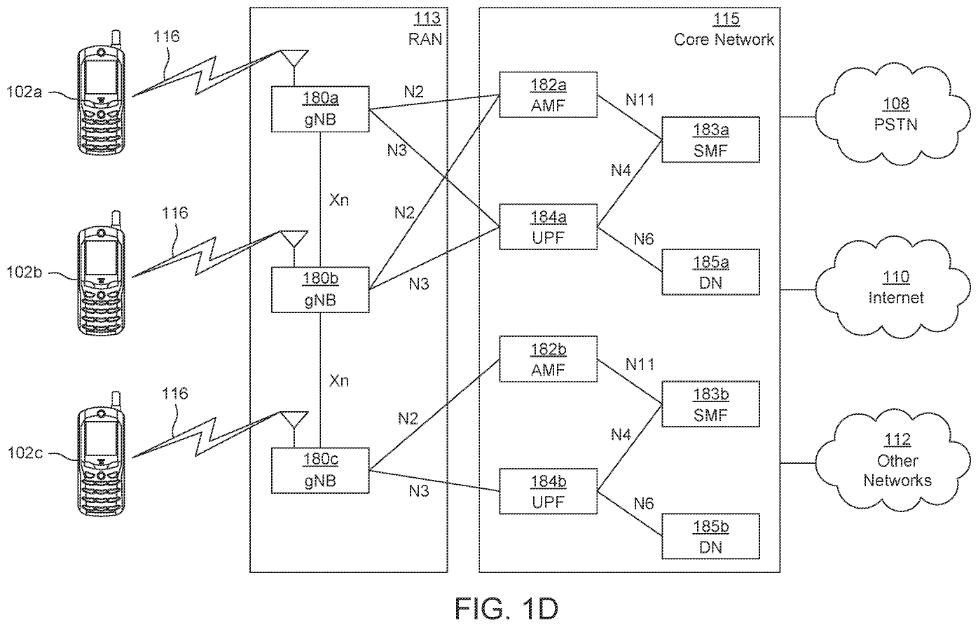

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a New Radio (NR) Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-ID as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example, in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The following description is for exemplary purposes and does not limit in any way the applicability of the methods described herein to a specific wireless technology, to a specific communication technology and/or to other technologies, when applicable. The term network in this disclosure may refer to one or more base stations (e.g., gNBs) which in turn may be associated with one or more Transmission/Reception Points (TRPs), or to any other physical and/or logical node in the radio access network.

According to embodiments, methods for the WTRU to determine one or more aspects related to generation and transmission of Channel State Information feedback (or parts thereof) using an AI model are disclosed.

Artificial intelligence/machine learning (AIML) based methods have the potential to improve the resolution CSI feedback and can increase performance at reduced CSI-RS overhead. Autoencoder is one of the AIML model architectures considered for CSI compression use cases. Autoencoder architecture may comprise (e.g., consist of) two parts, an encoder AIML model (at the WTRU) and a decoder AI model (at the base station (e.g., gNB)). In some cases, both the encoder and encoder AIML models are jointly trained/designed. Encoder/Decoder may have multiple layers—In encoder, the output of each layer is smaller than its input—(vice versa for decoder). Typically, larger number of layers may imply higher model complexity, higher storage requirement, higher training complexity and for example, also better performance/better compression ratio.

For autoencoder based architectures to work the decoder typically utilizes some knowledge about the encoder which was used for compression/encoding. More than one encoder model may be defined for CSI compression for various reasons. For example:
Designing a single encoder to have better performance under different scenarios (e.g., Signal-to-Noise Ratio (SNR), doppler etc.) is complicated (e.g., increases training time, model complexity, model size etc.). Multiple smaller encoders optimized for specific scenario may be preferred.
Multiple encoder models may be defined to meet different requirements for the base station (e.g., gNB) scheduler (e.g., low latency CSI, high resolution CSI, low overhead CSI etc.).
Different WTRU vendors may choose to implement different encoders (among a predefined set) to tradeoff between cost, complexity, and performance.

For the autoencoder based architectures to work, the decoder may need to know which encoder was used.

If more than one encoder model is configured, the WTRU may determine which encoder is selected for CSI processing, and/or the WTRU may indicate the selected encoder model to the base station (e.g., gNB).

### 1. Artificial Intelligence (AI)

Artificial intelligence may be broadly defined as the behavior exhibited by machines. Such behavior may e.g., mimic cognitive functions to sense, reason, adapt and act.

### 1.1. Machine Learning (ML)

### [General Principles of ML]

Machine learning may refer to types of algorithms that solve a problem based on learning through experience (‘data’), without explicitly being programmed (‘configuring set of rules’). Machine learning can be considered as a subset of AI. Different machine learning paradigms may be envisioned based on the nature of data or feedback available to the learning algorithm. For example, a supervised learning approach may involve learning a function that maps input to an output based on labeled training example, wherein each training example may be a pair comprising (e.g., consisting) of input and the corresponding output. For example, unsupervised learning approaches may involve detecting patterns in the data with no pre-existing labels. For example, reinforcement learning approach may involve performing sequence of actions in an environment to maximize the cumulative reward. In some embodiments, it is possible to apply machine learning algorithms using a combination or interpolation of the above-mentioned approaches. For example, a semi-supervised learning approach may use a combination of a small amount of labeled data with a large amount of unlabeled data during training. In this regard semi-supervised learning falls between unsupervised learning (with no labeled training data) and supervised learning (with (e.g., only) labeled training data).

### 1.2. Deep Learning (DL)

Deep learning refers to a class of machine learning algorithms that employ artificial neural networks (specifically DNNs) which were loosely inspired from biological systems. The Deep Neural Networks (DNNs) are a special class of machine learning models inspired by the human brain wherein the input is linearly transformed and pass-through non-linear activation function multiple times. DNNs may typically comprise (e.g., consist of) multiple layers where each layer may comprise (e.g., consist of) linear transformation and a given non-linear activation functions. The DNNs can be trained using the training data via back-propagation algorithm. Recently, DNNs have shown state-of-the-art performance in a variety of domains, e.g., speech, vision, natural language etc. and for various machine learning settings supervised, un-supervised, and semi-supervised. The term AIML based methods/processing may refer to realization of behaviors and/or conformance to requirements by learning based on data, without explicit configuration of sequence of steps of actions. Such methods may enable learning complex behaviors which might be difficult to specify and/or implement when using legacy methods.

### 1.3. Autoencoder

Auto-encoders are specific class of DNNs that arise in context of un-supervised machine learning setting wherein the high-dimensional data is non-linearly transformed to a lower dimensional latent vector using the DNN based encoder and the lower dimensional latent vector is then used to re-produce the high-dimensional data using a non-linear decoder. The encoder is represented as E(x; Wₑ) where x is the high-dimensional data and Wₑ represents the parameters of the encoder. The decoder is represented as D(z; W_{d}) where z is the low-dimensional latent representation and W_{d} represents the parameters of the decoder. Further, using training data {x₁, . . . , x_{N}} the auto-encoder can be trained by solving the following optimization problem

$$\{ {W}_{e}^{tr} , {W}_{d}^{tr} \} = arg {min}_{{W}_{e} , {W}_{d}} {\sum }_{i = 1}^{N} {‖ {x}_{i} - D ( E ( {x}_{i} ; {W}_{e} ) ; {W}_{d} ) ‖}_{2}^{2} .$$

The above problem can be approximately solved using a backpropagation algorithm. The trained encoder E(x; Wₑ^{tr}) can be used to compress the high-dimensional data and trained decoder D(z; W_{d}^{tr}) can be used to decompress the latent representation.

The terms AI, ML, DL, DNNs may be used interchangeably. Methods described herein are exemplified based on learning in wireless communication systems. The methods are not limited to such scenarios, systems and services and may be applicable to any type of transmissions, communication systems and/or services etc.

### 2. CSI Reporting

Channel State Information may include at least one of the following: channel quality index (CQI), rank indicator (RI), precoding matrix index (PMI), an L1 channel measurement (e.g., Reference Signal Received Power (RSRP) such as L1-RSRP, or Signal-to-Interference Ratio (SINR)), CSI-RS resource indicator (CRI), SS/PBCH block resource indicator (SSBRI), layer indicator (LI) and/or any other measurement quantity measured by the WTRU from the configured reference signals (e.g. CSI-RS or SS/PBCH block or any other reference signal).

### 2.1. CSI Reporting Framework

A WTRU may be configured to report the CSI through the uplink control channel on Physical Uplink Control Channel (PUCCH), or per the base stations' (e.g., gNBs') request on an UL Physical uplink shared channel (PUSCH) grant. Depending on the configuration, CSI-RS can cover the full bandwidth of a BandWidth Part (BWP) or just a fraction of it. Within the CSI-RS bandwidth, CSI-RS can be configured in each Physical Resource Block (PRB) or every other PRB. In the time domain, CSI-RS resources can be configured either periodic, semi-persistent, or aperiodic. Semi-persistent CSI-RS is similar to periodic CSI-RS, except that the resource can be (de)-activated by MAC Control Elements (MAC CEs); and the WTRU reports related measurements (e.g., only) when the resource is activated. For Aperiodic CSI-RS, the WTRU is triggered to report measured CSI-RS on PUSCH by request in a Downlink Control Information (DCI). Periodic reports are carried over the PUCCH, while semi-persistent reports can be carried either on PUCCH or PUSCH. The reported CSI may be used by the scheduler when allocating optimal resource blocks, for example, based on channel's time-frequency selectivity, determining precoding matrices, beams, transmission mode and selecting suitable Modulation and Coding Schemes (MCSs). The reliability, accuracy, and timeliness of WTRU CSI reports may be critical to meeting URLLC service requirements.

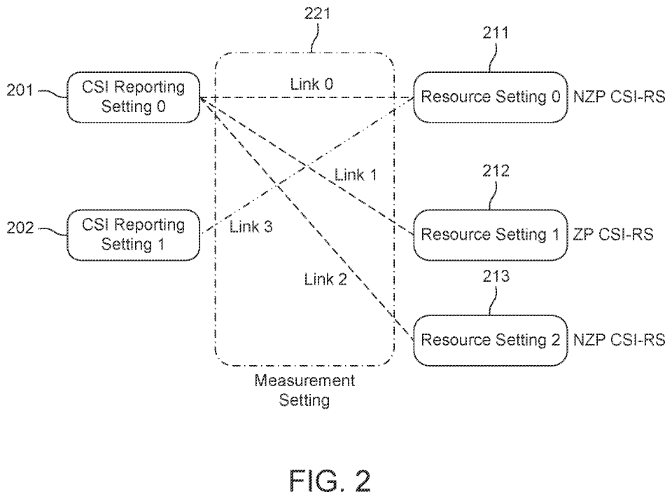

A WTRU may be configured with a CSI measurement setting which may include one or more CSI reporting settings, resource settings, and/or a link between one or more CSI reporting settings and one or more resource settings. FIG. 2 shows an example of a configuration for CSI reporting settings, resource settings, and link.

In a CSI measurement setting, any of the following configuration parameters may be provided:
N≥1 CSI reporting settings 201, 202, M≥1 resource settings 211, 212, 213, and a CSI measurement setting which links the N CSI reporting settings with the M resource settings.
A CSI reporting setting 201, 202 may include any of the following:
   Time-domain behavior: aperiodic or periodic/semi-persistent.
   Frequency-granularity, at least for PMI and CQI.
   CSI reporting type (e.g., PMI, CQI, RI, CRI, etc.).
   If a PMI is reported, PMI Type (Type I or II) and/or codebook configuration.
A Resource setting 211, 212, 213 may include any of the following:
   Time-domain behavior: aperiodic or periodic/semi-persistent.
   RS type (e.g., for channel measurement or interference measurement).
   S≥1 resource set(s) and each resource set can contain Ks resources.
A CSI measurement setting 221 may include at least one of the following:
   One CSI reporting setting.
   One resource setting.
   For CQI, a reference transmission scheme setting.
CSI reporting for a component carrier, at any of the following frequency granularities may be supported:
   Wideband CSI.
   Partial band CSI.
   Sub band CSI.

### Codebook Based Nrecodine

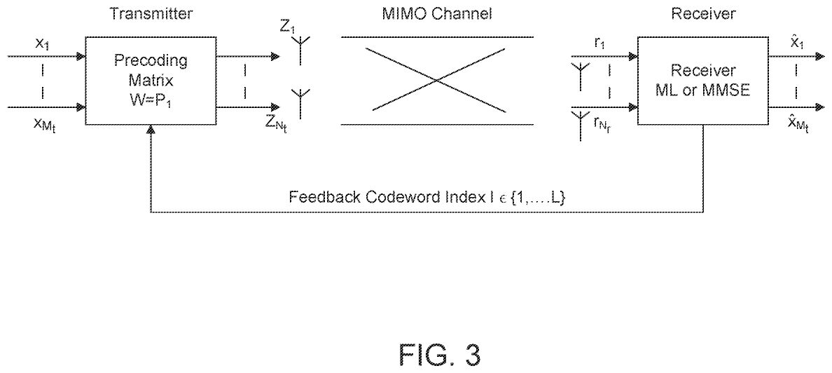

FIG. 3 shows a basic concept of codebook-based precoding with feedback information. The feedback information may include a PMI which may be referred to as a codeword index in the codebook as shown in the figure.

As shown in FIG. 3, a codebook includes a set of precoding vectors/matrices for each rank and the number of antenna ports, and each precoding vectors/matrices has its own index so that a receiver may inform preferred precoding vector/matrix index to a transmitter. The codebook-based precoding may have performance degradation due to its finite number of precoding vector/matrix as compared with non-codebook-based precoding. However, one advantage, for example, of a codebook-based precoding could be lower control signaling/feedback overhead. Table 1 shows an example of codebook for 2Tx.

TABLE 1
Tx downlink codebook

| Codebook | Number of rank | |
|---|---|---|
| index | 1 | 2 |
| 0 | $\frac{1}{\sqrt{2}} [ \begin{matrix}1 \\ 1\end{matrix} ]$ | $\frac{1}{\sqrt{2}} [ \begin{matrix}1 & 0 \\ 0 & 1\end{matrix} ]$ |
| 1 | $\frac{1}{\sqrt{2}} [ \begin{matrix}1 \\ - 1\end{matrix} ]$ | $\frac{1}{2} [ \begin{matrix}1 & 1 \\ 1 & - 1\end{matrix} ]$ |
| 2 | $\frac{1}{\sqrt{2}} [ \begin{matrix}1 \\ j\end{matrix} ]$ | $\frac{1}{2} [ \begin{matrix}1 & 1 \\ j & - j\end{matrix} ]$ |
| 3 | $\frac{1}{\sqrt{2}} [ \begin{matrix}1 \\ - j\end{matrix} ]$ | — |

### CSI Processing Criteria

A CSI processing unit (CPU) may be referred to as a minimum CSI processing unit and a WTRU may support one or more CPUs (e.g., N CPUs). A WTRU with N CPUs may estimate N CSI feedbacks calculation in parallel, wherein N may be a WTRU capability. If a WTRU is requested to estimate more than N CSI feedbacks at the same time, the WTRU may perform high priority N CSI feedbacks and the rest may be not estimated.

The starts and/or ends of a CPU may be determined based on the CSI report type (e.g., aperiodic, periodic, semi-persistent) as follows:
For aperiodic CSI report, a CPU may start to be occupied from the first OFDM symbol after the Physical Downlink Control channel (PDCCH) trigger until the last OFDM symbol of the PUSCH carrying the CSI report.
For periodic and semi-persistent CSI report, a CPU may start to be occupied from the first OFDM symbol of one or more associated measurement resources (e.g., not earlier than CSI reference resources) until the last OFDM symbol of the CSI report.
   The number of CPUs occupied may be different based on the CSI measurement types (e.g., beam-based or non-beam based) as exemplified in the following:
Non-beam related reports:
   Ks CPUs when Ks CSI-RS resources in the CSI-RS resource set for channel measurement.
Beam-related reports (e.g., “cri-RSRP”, “ssb-Index-RSRP”, or “none”):
   1 CPU irrespective the number of CSI-RS resource in the CSI-RS resource set for channel measurement due to the CSI computation complexity is low.
   “none” may be used for P3 operation or aperiodic Tracking Reference Signal (TRS) transmission.
For an aperiodic CSI reporting with a single CSI-RS resource, 1 CPU may be occupied.
For a CSI reporting Ks CSI-RS resources, Ks CPUs may be occupied as WTRU may (e.g., need to) perform CSI measurement for each CSI-RS resource.

If (e.g., when) the number of unoccupied CPUs (N_u) is less than required CPUs (N_r) for CSI reporting, the following WTRU behavior may be used:
The WTRU may drop N_r−N_u CSI reporting based on priorities in the case of Uplink Control Information (UCI) on PUSCH without data/Hybrid Automatic Repeat reQuest (HARQ).
The WTRU may report dummy information in Nr−Nu CSI reporting, for example, based on priorities in other case to avoid rate-matching handling of PUSCH.

### 3. Types of Processing

### 3.1. Legacy Processing

According to embodiments, the term legacy processing may refer to specified WTRU behavior and/or requirements explicitly defined in the form of procedural text, signaling syntax or the like. The term legacy processing may also refer to any processing based on legacy algorithms that are (e.g., essentially) non-AIML based. The terms legacy processing, rule-based processing, conventional processing/scheme, and baseline processing may be used interchangeably. For example, for the use case of CSI feedback, the legacy processing may involve the steps outlined in the section 2.

### 3.2. AIML Processing

According to embodiments, the term AIML processing may refer to specified WTRU behavior and/or processing or parts thereof that are learned based on training using data. AIML processing may involve one or more of classical machine learning techniques and/or deep learning techniques. AIML processing may apply one or more AI model architectures to perform one or more of classification, prediction, pattern recognition, dimensionality reduction, estimation, interpolation, clustering, regression, compression, recommendation, approximation of an arbitrary function etc. AIML processing may utilize supervised, unsupervised, reinforcement learning or a variant thereof. For example, AIML model applying AIML processing may be trained by various techniques such offline training, online training, online refinement, or a combination of the above. For example, such training may be performed locally on the WTRU, partially on the WTRU or downloaded from the network.

Principle Means to Introduce and/or Control the Extent of AIML within the Protocol

A protocol layer may be defined using one or more processing blocks. Each processing block may have well defined/specified input and outputs. Herein the processing block can be either implemented as rule-based steps or using an AIML model. In some embodiments, the processing block may be dynamically configured to be rule-based, or AIML based. For example, the AIML model behavior may be affected by training data. For example, the behavior of the AIML model and/or its parameterization may be impacted by one or more of the following: Network (NW) configuration, WTRU implementation, application configuration or a default/reference AI model configuration. Further, the AI component may be configurable to achieve different levels of performance e.g., configurable processing complexity/accuracy/power consumption/granularity etc.

A function associated with a protocol layer may be realized by means of one or cascading of more than one processing blocks, wherein each processing block may implement a specific sub-task. In some realizations, the cascading may also include piecing together various processing blocks in a sort of interlocking (‘Lego’ like) arbitrary patterns. For example, the processing blocks may be arranged in sequence, wherein output of one processing block may be an input to another processing block. For example, the processing block may be arranged in parallel, wherein the output of one processing block may be input to two or more processing blocks. For example, the output of two or more processing blocks may be input one processing block. For example, the input of a processing block at time T may be an output of the same or different processing block from T-n. For example, the values of n may be preconfigured (e.g., a default may be 1 or previous time instance).

According to embodiments, a WTRU may be configured with an AIML model communicatively linked to a remote AIML model over a wireless channel. According to embodiments, the AIML model at the WTRU may correspond to an encoder function and the remote AIML model may be a decoder function. According to embodiments, the AIML model at the WTRU may correspond to a decoder function and the remote AIML model may be an encoder function. For example, the AIML model may include at least in part deep neural network. According to embodiments, the encoder and decoder herein may be coupled to form an autoencoder architecture. According to embodiments, the AIML model may be located in the WTRU and the remote AIML model may be located in the network. For example, such encoder/decoder architecture may be applied for functions such as CSI feedback determination and/or compression.

### 4. Problem Statement

AI/ML in Terminal Device with Autonomous or NW-Controlled Behavior, or Over the Air Interface

AI including ML, may be applied to wireless transmitters and/or to wireless receivers. AI/ML may be used to improve one or more specific aspect(s), function(s) or protocol(s) operation of a wireless node e.g., either as a local optimization within a node and/or as part of a function, or procedure over the air interface (AI-AI). There may be several challenges associated with supporting artificial intelligence in a communication system, or within a communication protocol stack.

In general, usage of AIML models within 3GPP framework and system impacts are not addressed in contributions/literature. For autoencoder based architectures to work the decoder may need to know what encoder was used. The procedure for model synchronization between WTRU and base station (e.g., gNB) should be defined. The following problems are addressed:
How should the WTRU determine if legacy processing or AIML processing should be applied.
If the WTRU decides to apply AIML processing, how should the WTRU determine what encoder should be used for CSI feedback generation.
How the WTRU may indicate the selected encoder model to the base station (e.g., gNB).

### 5. Methods for Multi-Resolution CSI Feedback for AI Based Wireless Systems

The methods described herein are applicable, without limitation, to any communication link that include two (point-to-point) or more (point-to-multipoint) communication devices such as 3GPP LTE Uu, 3GPP NR Uu, 3GPP Sidelink, IEEE Wi-Fi technologies including protocols for wireless air interfaces and device-to-device communications with or without relaying capabilities. Methods described herein are applicable for both the WTRU-based (e.g., UE-based) and the NW-based approach, for example, over either Uu interface or a sidelink-based SL interface. Exemplary embodiments are however described based on a wireless-related function being executed in a mobile terminal (e.g., a WTRU/UE) in the context of cellular communications.

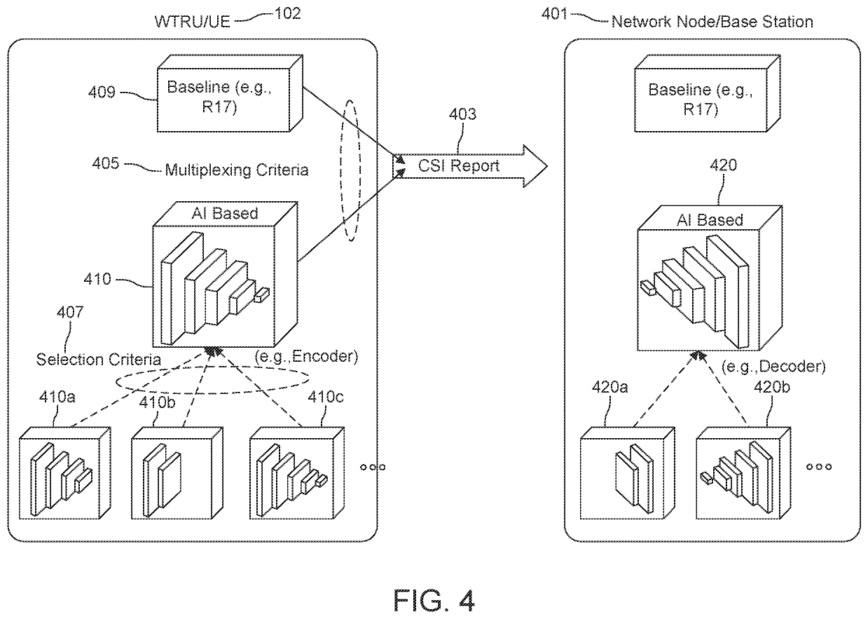

As illustrated in FIG. 4, the WTRU 102 may be configured with an AIML model 410 to perform at least one action associated with CSI feedback generation and transmission. According to embodiments, the configured AIML model 410 may correspond to encoder portion of autoencoder architecture. For example, the network node/base station 401 (e.g., gNB) may process CSI feedback generated by the encoder AIML model 410 using a decoder portion of the autoencoder architecture.

### Multiplexing Criteria 405

The CSI feedback may comprise multiple components, e.g., CQI, PMI—including different types of PMI (type 1, type 2 etc.), CSI-RS resource indicator (CRI), SS/PBCH Block Resource indicator (SSBRI), layer indicator (LI), rank indicator (RI), L1-RSRP or L1-SINR etc. Additional types of feedbacks may be envisioned capturing some statistical characteristics of the channel e.g., explicit channel matrix, covariance channel matrix, average/standard deviation of SINR etc.

According to embodiments, the WTRU may be configured to generate a complete CSI report 403 using AIML model 410 at a first-time instance and generate a complete CSI report 403 using the legacy processing 409 during a second time instance. The WTRU may be configured with multiplexing rules 405 to determine what type of processing should be applied for a CSI report generation in a specific time instance. According to embodiments, the WTRU may generate CSI report 403 using a combination of both AIML model 410 and legacy processing 409. For example, the WTRU may derive channel estimates using legacy processing 409 and apply the derived channel estimates as input to the AIML model 410. According to embodiments, the WTRU may generate a first part of the CSI report 403 using AIML model 410 and the second part of the CSI report 403 using legacy CSI processing 409. The WTRU may be configured with multiplexing criteria 405 to determine any of the following:
When the CSI feedback is generated by an AIML model.
If a portion of the CSI feedback is generated by an AIML model. For example, AIML based processing may be applied for PMI reports and legacy processing may be applied for CRI, L1-RSRP, etc.
How much of the CSI feedback is generated by an AIML model.

### Selection Criteria

According to embodiments, the WTRU may be configured with a selection criterion to select a subset of AIML models from a set of preconfigured AIML models for CSI processing. The WTRU may then use one or more of the selected AIML models for CSI processing. Herein different AIML models may be associated with different characteristics, for example any of the following:
Different AIML models may be optimized for better performance under specific scenarios (e.g., SNR, doppler etc.).
Different AIML models may be configured to meet different requirements for the base station (e.g., gNB) scheduler (e.g., low latency CSI, high resolution CSI, low overhead CSI etc.).
Different AIML models may be configured to enable tradeoff between memory requirements, processing requirements, complexity, performance etc.

### 5.1. Methods for AIML Model Configuration

Model Paring for CSI Compression˜e.g., when Plurality of Encoder Decoder Pairs is Predefined

According to embodiments, plurality of encoder and/or decoder AIML models for CSI feedback generation may be predefined. A WTRU may be configured with a plurality of encoder AIML models. According to embodiments, the WTRU may acquire encoder AIML model from the network via broadcast and/or unicast signaling. Each AIML model may be identified by a logical identity.

The AIML models at the WTRU and base station (e.g., gNB) may need to be paired (herein referred to as ‘model pairing’) for a proper autoencoder operation. The pairing may be based on one-to-one or one-to-many or many-to-many relationships between AIML models. According to embodiments, an association between encoder model and corresponding decoder model may be predefined. According to embodiments, the WTRU may be configured with the mapping between each encoder AIML model and a decoder AIML model. According to embodiments, the WTRU may be configured with a cell specific mapping between the encoder AIML model and decoder AIML model. The WTRU may assume that the mapping is valid within the serving cell and/or base station (e.g., gNB) and may not assume that the mapping is valid in a different serving cell and/or base station (e.g., gNB). According to embodiments, the WTRU may be configured with WTRU specific mapping between encoder AIML model and decoder AIML model. The WTRU may operate with (e.g., assume) a default mapping or a cell specific mapping until configured with a WTRU specific mapping.

### Decoder Based AIML Model Pairing

According to embodiments, the WTRU may be configured to select the encoder AIML model as a function of decoder AIML model used at the base station (e.g., gNB). For example, the WTRU may receive an indication of a logical identity associated with the decoder model at the base station (e.g., gNB). The WTRU may select the corresponding paired encoder (based on the predefined and/or configured mapping) for CSI compression. For example, the WTRU may receive the indication of decoder used at the base station (e.g., gNB) in a system information message. For example, the WTRU may receive the indication of decoder used at the base station (e.g., gNB) in a Radio Resource Control (RRC) reconfiguration or RRC setup message.

### Encoder Based AIML Model Pairing

According to embodiments, the WTRU may be preconfigured with rules to select the encoder AIML model. The WTRU may be configured to indicate the selected encoder AIML model to the base station (e.g., gNB). For example, the WTRU may be configured to transmit an indication to the base station (e.g., gNB) to inform and/or assist model pairing between the encoder at the WTRU and corresponding decoder at the base station (e.g., gNB). For example, such indication may be transmitted during initial access procedure. According to embodiments, the WTRU may (e.g., implicitly) indicate the logical identity associated with AIML model. For example, based on a preconfigured association between random access resource (e.g., time, frequency and/preamble resource) and AIML model identity. According to embodiments, the WTRU may (e.g., explicitly) indicate the logical identity associated with AIML model. For example, the WTRU may transmit the AIML model identity in msgB of two step Random Access Channel (RACH) procedure. For example, the WTRU may transmit the AIML model identity in an RRC message (e.g., RRC setup request message or RRC resume request, WTRU assistance information, WTRU capability information, RRC Reconfiguration Complete, etc.).

According to embodiments, a combination of decoder and encoder-based model pairing may be used. For example, the WTRU may implement E (where E>=1) encoder models. The WTRU may receive the list of supported decoders models D (where D>=1) at the base station (e.g., gNB). The WTRU may select a subset of encoders S (where S>=1 and S<=E and S<=D) that can be paired based on the list of supported decoders at the base station (e.g., gNB). The WTRU may indicate the selected subset S to the base station (e.g., gNB). The base station (e.g., gNB) may further configure a restricted subset R (where R<=S) of encoders applicable for CSI compression. At any time instance the WTRU may choose the encoder for CSI compression within the set R based on an indication from the base station (e.g., gNB). Such an indication may, for example, be semi-static based on activation/deactivation command received or dynamic based on indication in a DCI field.

### Signaling to Configure/Enable AI Based CSI Feedback

The WTRU may determine whether to apply AIML based processing for CSI feedback or legacy processing CSI feedback based on one or configuration elements in the RRC signaling (e.g., CSI-MeasConfig), MAC CE (e.g., activation deactivation of specific CSI resource sets, based on selection of Aperiodic CSI trigger states, activation/deactivation of semi-persistent CSI reporting, activation/deactivation of preconfigured CSI-RS resource sets etc.), indication in a DCI carrying CSI request (e.g., Aperiodic CSI request).

For example, the WTRU may determine that the AI based CSI compression should be applied based on any of the following conditions:
Based on Report configuration:
   The WTRU may apply AIML based CSI feedback if a report configuration contains a new report quantity or an existing report quantity for which AIML based compression is preconfigured. For example, when configured with a report quantity CSI-RS Resources Indicator (CRI)-CQI-NQ—the WTRU may apply legacy mechanism for CRI and CQI generation and apply AIML based feedback for NQ—where NQ is a New-report Quantity or an existing report quantity (e.g., PMI) for which AIML based feedback is preconfigured.
Based on codebook configuration:
   The WTRU may apply AIML based CSI feedback if the codebook type is not specified or configured.
   The WTRU may apply legacy CSI feedback if the codebook type is type1 or type2. The WTRU may apply AIML based CSI feedback if the codebook type is configured as type3.
Based on PUCCH CSI Resource config:
   The WTRU may apply AIML based CSI feedback based on PUCCH resource configuration. For example, if the PUCCH resource corresponds to a PUCCH resource ID or PUCCH format preconfigured for AIML based CSI feedback.
Based on CSI-RS Resource configuration:
   The WTRU may apply AIML based CSI feedback based on CSI RS resource configuration. For example, CSI-RS resource ID or CSI-RS resource set or CSI-RS resource type preconfigured for AIML based CSI feedback.
Based on linkage between report config and an AIML model configuration:
   The WTRU may be preconfigured with one or more AIML models. For example, in a CSI-AI-modelToAddModList. The WTRU may receive one or more report configurations and a linkage between report configuration and the AIML model ID in the CSI-AI-modelToAddModList. If (e.g., when) a triggered CSI report is associated with the report configuration, the WTRU may apply AIML based processing if the report configuration is linked to an AIML model and apply legacy processing otherwise.

### 5.2. Methods for AIML Model Selection

### 5.2.1. Implicit Determination of AIML Model Based on CSI Processing Capability

### CSI Processing Unit (CPU) Type Definition for AIML Based CSI Compression

According to embodiments, one or more types of CPU may be used, and each CPU type may be associated with a CSI compression scheme. For example, a first CPU type may be used for a CSI reporting based on a conventional CSI compression and a second CPU type may be used for a CSI reporting based on an AIML based CSI compression. Any of the following may apply:
A WTRU may report or indicate its capability of number of CPUs supported for a first CPU type and a second CPU type, respectively. For example, a WTRU may report its capability of N1 CPUs (e.g., first CPU type) and N2 CPUs (e.g., second CPU type), wherein N1 CPUs may be used for processing first CSI reporting type (e.g., conventional CSI compression) and N2 CPUs may be used for processing second CSI reporting type (e.g., AIML based CSI compression).
One or more of the first CPU types may be occupied for a first time period when a WTRU performs conventional CSI compression (e.g., non-AIML based compression, measuring CSI reporting quantities including PMI, CQI, RI, LI, L1-RSRP, etc.), wherein the conventional CSI compression may include at least one of measurement of a reference signal, estimation of a channel, and calculation of one or more CSI reporting quantities.
   The first time period may start from the first OFDM symbol after the PDCCH trigger and end in the last OFDM symbol of the PUSCH carrying the CSI report for an aperiodic CSI reporting.
   The first time period may start from the first OFDM symbol of one or more associated measurement resources and end in the last OFDM symbol of the PUCCH or PUSCH carrying the CSI report for a periodic or a semi-persistent CSI reporting.
   If (e.g., when) the number of unoccupied CPUs for a first CPU type (N1_u) is less than required CPUs for first CPU type (N1_r), a WTRU may drop or send dummy CSI for the CSI reporting with no CPU assigned. In this case, unoccupied CPUs for second CPU type (N2_u) may not be used for the CSI reporting associated with the first CPU type.
One or more of the second CPU types may be occupied for a second time period when a WTRU performs AIML based CSI compression, wherein the AIML based CSI compression may include at least one of measurement of a reference signal, determining an AIML model, determining input dimension of the AIML model, determining inputs of the AIML model, performing the AIML model, and determining output of the AIML model.
   The second time period (and/or the starting OFDM symbol) may be determined based on any of the following:
      CSI reporting type (e.g., periodic, aperiodic, semi-persistent).
      Measurement type (e.g., beam-based, non-beam based).
      Number of antenna ports to measure (e.g., 1, 2, 4, 8, 16, 32 antenna ports), wherein the number of antenna ports may be associated with the measurement reference signal (e.g., CSI-RS) for channel measurement.
      CSI reporting bandwidth and/or CSI-RS bandwidth.
      Codebook type (e.g., single-panel type 1, multi-panel type 2, single-panel type 2).
      Subcarrier spacing.
      Frequency band (e.g., FR1, FR2-1, FR2-2).
      AIML model (or AIML model identity).
      CSI compression level (e.g., number of output bits from an AIML model).
      Input dimension (e.g., input dimension or number of input bits of the AIML model).
   If (e.g., when) the number of unoccupied CPUs for a second CPU type (N2_u) is less than required CPUs for second CPU type (N2_r), a WTRU may perform any of the following:
      Drop a CSI reporting with no CPU assigned.
      Send dummy information for a CSI reporting with no CPU assigned.
      Change AIML model which may require lower number of CPUs.

CSI compression schemes using AIML models may be interchangeably used with any of: AIML compression, AIML CSI, and AIML CSI reporting.

CSI reporting may be interchangeably used with any of: CSI measurement, CSI estimation, CSI derivation, CSI calculation, CSI computation, and CSI compression.

### CPU Sharing Between Conventional Based CSI Compression and AIML Based CSI Compression

A WTRU may support or indicate capability of N CPUs and the N CPUs may be used for a CSI reporting irrespective of CSI compression scheme. For example, k1 CPUs may be occupied when a CSI reporting with conventional CSI compression is triggered and k2 CPUs may be occupied when a CSI reporting with AIML based CSI compression is triggered.

According to embodiments, the number of CPUs (e.g., k2) occupied for a CSI reporting with AIML based CSI compression may be determined based on any of the following:
Number of layers used or implemented for the associated AIML model.
Input dimension (e.g., number of bits, number of samples, number of time samples aggregated, number of frequency samples aggregated) for the associated AIML model.
Number of AIML models used for the CSI compression, wherein a first AIML model may be used to determine an input of a subsequent AIML model for CSI compression.
Processing capability of AIML model at the WTRU, wherein the processing capability may be indicated or reported to a base station (e.g., gNB) as a WTRU capability.
Identity of the associated AIML mode used for the CSI compression.
CSI reporting type (e.g., periodic, aperiodic, semi-persistent).
Measurement type (e.g., beam-based, non-beam based).
Number of antenna ports to measure (e.g., 1, 2, 4, 8, 16, 32 antenna ports), wherein the number of antenna ports may be associated with the measurement reference signal (e.g., CSI-RS) for channel measurement.
CSI reporting bandwidth and/or CSI-RS bandwidth.
Codebook type (e.g., single-panel type 1, multi-panel type 2, single-panel type 2).
Subcarrier spacing.
Frequency band (e.g., FR1, FR2-1, FR2-2).

According to embodiments, if (e.g., when) the number of unoccupied CPU (N_u) is less than the number of required CPU (N_r) for one or more CSI reporting triggered or configured, a WTRU may perform any of the following:
The WTRU may prioritize a CSI reporting with AIML based compression over a CSI reporting with conventional CSI compression. The CSI reporting with no CPU assigned may be dropped or dummy information may be reported. Alternatively, the WTRU may prioritize a CSI reporting with conventional CSI compression over a CSI reporting with AIML based compression.
The WTRU may prioritize one or more CSI reporting with AIML based compression based on the required number of CPUs. For example, a CSI reporting requiring a smaller number of CPUs may be prioritized higher over a CSI reporting requiring larger number of CPUs, or vice versa.
The WTRU may determine an AIML model requiring a smaller number of CPUs. For example, one or more AIML models may be used for CSI compression and each AIML model may require a number of CPUs, wherein the required number of CPUs may be different per AIML model. When N_u<N_r, the WTRU may determine an AIML model which may minimize or reduce the gap N_g=N_r−N_u.
The WTRU may determine to fall back to conventional CSI compression when N_u<N_r, wherein the number of CPUs required for a conventional CSI compression may be smaller than the number of CPUs required for an AIML based CSI compression.

A CSI reporting with AIML based CSI compression may be referred to as AIML based CSI reporting and a CSI reporting with conventional CSI compression may be referred to as conventional CSI reporting.

According to embodiments, a WTRU may determine an AIML model for an AIML based CSI reporting based on the number of unoccupied CPUs (N_u) when one or more AIML based CSI reporting are triggered. For example, if (e.g., when) an AIML based CSI reporting is triggered, requested, or determined, a WTRU may determine AIML model for the AIML based CSI reporting based on the number of unoccupied CPUs. The WTRU may determine a first AIML model when N_u is less than a threshold (N_u<threshold) and the WTRU may determine a second AIML model when N_u is equal to or greater than the threshold (N_u≥threshold). Any of the following may apply:
The required number of CPUs for an AIML model may be predetermined, configured, or indicated as a WTRU capability.
The threshold may be determined as a function of N_u.
The threshold may be predetermined or configured by base station (e.g., gNB).

According to embodiments below, the WTRU may be configured with any of the following parameters related to CSI processing:

O_{CPU}^{AI1}—Number of CPUs occupied when a first type of AIML model is used for CSI processing—the first type of AIML model may be configured for low latency and/or low computational complexity CSI processing and/or for a first range of input dimension and/or output dimension.

O_{CPU}^{AI2}—Number of CPUs occupied when a second type of AIML model is used for CSI processing—the second type of AIML model may be configured for higher compression and/or higher resolution CSI processing and/or a second range of input dimension and/or output dimension

O_{CPU}^{AIx}, O_{CPU}^{AIy}, O_{CPU}^{AIz}—Number of CPUs occupied when different types of AIML models X, Y and Z are used for CSI processing—each type of AIML model may differ in at least one of compression ratio and/or of resolution CSI processing and/or input dimension and/or output dimension and/or processing complexity.

According to embodiments, the WTRU may be configured to select AIML model for CSI processing such that the number of generated CSI reports is maximized. According to embodiments, the WTRU may be configured to select AIML model for CSI processing such that the latency to generate CSI reports are minimized. For example, If L CPUs are occupied for calculation of CSI reports in a given OFDM symbol, the WTRU has N_{CPU}−L unoccupied CPUs. If N CSI reports start occupying their respective CPUs on the same OFDM symbol on which N_{CPU}−L CPUs are unoccupied, and if the WTRU is configured for low latency (e.g., either implicitly based on PUCCH resource timing or explicitly as part of CSI config) the WTRU is not required to update the N−M requested CSI reports with lowest priority (according to Clause 5.2.5 in TS 38.214), where 0≤M≤N is the largest value such that Σₙ₌₀^{M-1}O_{CPU}^{AI1}≤N_{CPU}−L holds.

According to embodiments, the WTRU may be configured to select AIML model for CSI processing such that the resolution of generated CSI reports is maximized. For example, If L CPUs are occupied for calculation of CSI reports in a given OFDM symbol, the WTRU has N_{CPU}−L unoccupied CPUs. If N CSI reports start occupying their respective CPUs on the same OFDM symbol on which N_{CPU}−L CPUs are unoccupied, and if the WTRU is configured for high resolution CSI feedback (e.g. either implicitly based on PUCCH resource timing or explicitly as part of CSI config) the WTRU is not required to update the N−M requested CSI reports with lowest priority (according to Clause 5.2.5 in TS 38.214), where 0≤M≤N is the largest value such that Σₙ₌₀^{M-1}O_{CPU}^{AI2}≤N_{CPU}−L holds.

If L CPUs are occupied for calculation of CSI reports in a given OFDM symbol, the WTRU has N_{CPU}−L unoccupied CPUs. If N CSI reports start occupying their respective CPUs on the same OFDM symbol on which N_{CPU}−L CPUs are unoccupied, and if the WTRU is configured to maximize the number of CSI reports the WTRU is not required to update the N−M requested CSI reports with lowest priority (according to Clause 5.2.5 in TS 38.214), where M=X+Y . . . +Z is the largest value such that Σₓ₌₀^{X-1}O_{CPU}^{AIx}+Σ_{y=0}^{Y-1}O_{CPU}^{AIy} . . . +Σ_{z=0}^{Z-1}O_{CPU}^{AIz}≤N_{CPU}−L holds.

According to embodiments, the WTRU may be configured as a first step, to select AIML model for CSI processing such that the resolution of generated CSI reports is maximized. If any more CPUs are left after the first step, then as a second step, the WTRU may be configured select AIML model to maximize the number of CSI reports that can be generated. For example, If L CPUs are occupied for calculation of CSI reports in a given OFDM symbol, the WTRU has N_{CPU}−L unoccupied CPUs. If N CSI reports start occupying their respective CPUs on the same OFDM symbol on which N_{CPU}−L CPUs are unoccupied, and if the WTRU is configured to maximize the combination of both the resolution of CSI report and the number of CSI reports, the WTRU is not required to update the N−M requested CSI reports where M=X+Y . . . +Z and the following conditions are true:

First, 0≤X≤N is the largest value such that Σₓ₌₀^{X-1}O_{CPU}^{AIx}≤N_{CPU}−L is true.

If additional CPUs left, then 0≤Y≤N is the largest value such that Σ_{y=0}^{Y-1}O_{CPU}^{AIy}≤N_{CPU}−L−Σₓ₌₀^{X-1}O_{CPU}^{AIx} and so on until no CPUs left or all the CSI processing complete whichever is earlier.

According to embodiments, the WTRU may be configured to determine AI model for CSI processing based on the priority CSI reports. For example, the WTRU may be configured for AI model X for highest priority CSI reports and AI model Y for the next priority CSI reports so on, until model Z for lowest priority CSI reports.

### 5.2.2. Implicit Determination of AIML Model Based on CSI Report Timing

The WTRU may choose between a legacy CSI reporting method and AIML method to compress the CSI report, and further between different available AIML models to compress the CSI report to varying degrees based on the amount of time available for CSI processing until CSI reporting time.

The WTRU may be configured with multiple AI models—with different sizes and correspondingly different compression ratios or quality. The inference latency for these models may be different based on different parameters, such as, e.g., their respective sizes, compression ratio, etc. This may determine the time-budget for CSI report generation. The base station (e.g., gNB) may (e.g., must) have knowledge of the model used by the WTRU for CSI compression to (e.g., correctly) perform the decompression.

The concept of CSI computation time has been introduced in NR:
1. Z_{ref} is defined as the next uplink symbol with its Cyclic Prefix (CP) starting T_{proc,CSI}=(Z)(2048+144)·κ2^{-μ}·T_{C}+T_{switch} after the end of the last symbol of the PDCCH triggering the CSI report(s), and
2. Z′_{ref}(n), is defined as the next uplink symbol with its CP starting T′_{proc,CSI}=(Z′)(2048+144)·κ2^{-μ}·T_{C} after the end of the last symbol of the aperiodic CSI resource, when aperiodic CSI-RS is used for channel measurement for the n-th triggered CSI report.

T_{c}=1/(Δfₘₐₓ·N_{f}) where Δfₘₐₓ=480·10³ Hz and N_{f}=4096. T_{switch} may be the duration to switch the UL transmission in case of carrier aggregation, supplementary uplink, dual connectivity, or the likes. K may be a constant, 64. μ may correspond to the min (μPDCCH, μCSI-RS, μUL) where the μPDCCH corresponds to the subcarrier spacing of the PDCCH with which the DCI was transmitted and μUL may correspond to the subcarrier spacing of the PUSCH with which the CSI report is to be transmitted and μCSI-RS may correspond to the minimum subcarrier spacing of the aperiodic CSI-RS triggered by the DCI. Z and Z′ may correspond to CSI computation delay, for example a maximum CSI computation delay among the plurality of CSI reports, wherein each CSI report may be associated with a preconfigured computation delay.

The value of Zref/Z′ref may depend on the type of CSI processing chosen by the WTRU, and may be defined for each case as ZrefAI/Z′refAI, ZrefNAI/Z′refNAI, ZrefAI1/Z′refA1 or ZrefAI2/Z′refAI2, where k=1, 2, 3, depending on whether AIML (when a single model is available)/non-AIML or Legacy/AIML model type 1 (for example, the first type of AIML model may be configured for low latency and/or low computational complexity CSI processing and/or for a first range of input dimension and/or output dimension)/AIML model type 2 (where the second type of AIML model may be configured for higher compression and/or higher resolution CSI processing and/or a second range of input dimension and/or output dimension) is used for CSI processing.

The steps of the embodiment may be presented as follows:
1. The WTRU may report (e.g., transmit information indicating) its capability (e.g., for AI processing, supported number of AI Models per CSI report quantity etc., Z_{ref}/Z′_{ref} for different processing types: Legacy/non-AIML, AIML model type 1, AIML model type 2, etc.).
2. The WTRU may receive a CSI configuration—including an implicit or explicit configuration of applicable AI models/parameterization etc.
   The CSIrequest field on a DCI triggers a CSI report(s) on PUSCH and may include the first uplink symbol to carry the corresponding CSI report(s) including the effect of the timing advance.
      The value of CSIRequest within DCI Format 0_1 may refer to a row in the aperiodicTriggerStateList look-up table that the WTRU obtained in the RRC Connection Reconfiguration message. This may contain the parameter aperiodicTriggeringOfset that specifies the number of slots following the slot in which the WTRU may receive the DCI 0_1 PDCCH message with the CSI Request, when the WTRU is supposed to perform the specified measurements on the CSI-RSs.
      Additionally, the DCI Format 0_1 may contain the PUSCH-TimeDomainResourceAllocation parameter, which further contains the parameter k2, that tells the WTRU when to transmit the CSI-RS measurement report via PUSCH after receiving the DCI 0_1 with CSIRequest.
      The combination of the parameters aperiodicTriggeringOfset and k2 specify the maximum time available to the WTRU for CSI processing.
   An indication of whether the WTRU may optimize the compression quality or reporting latency when computing the CSI Report.
3. The WTRU may choose between Legacy/Non-AIML, AIML, one of multiple available AIML models for CSI report processing based on preconfigured rules.
   at least one aspect may be:
      The extent of AI processing (none, some, all).
      Which AI model(s) to use.
      Which/how many CSI report to transmit.
   Preconfigured rules based on
      UE AI processing capability: CSI computation time
         The CSI Request field on a DCI includes a reporting latency greater than Zₖ^{AI1} and less than Zₖ^{AI2}, where k=1, 2, 3, the WTRU selects AIML model type 1.
         The CSI Request field on a DCI includes a reporting latency greater than both Zₖ^{AI1} and Zₖ^{AI2}, where k=1, 2, 3, and indicates that the WTRU should optimize compression quality, then the WTRU selects AIML model type 2.

According to embodiments, the WTRU may be configured to determine the processing time (e.g., required) for CSI processing, for example, as a function of whether the AIML model was used in the N previous instance of CSI processing. An additional model switching time T_{model_switch}( ) may be required to load the required model in the inference hardware. The switching time may be small or zero if the required model is already loaded on the inference hardware. This may occur if, for example, the model was used previously in one of the last N instances of CSI reporting, and therefore, loading from memory is not required. The switching time may operate with (e.g., assume) a larger value, corresponding to loading the model from memory into the inference hardware, under different set of conditions, e.g., if the required model was not used in the previous N instances of CSI reporting. The value of N may be a WTRU capability parameter.
Then T_{model_switch} is added to the appropriate Zₖ/Z′ₖ, where k=1, 2, 3, to determine Z_{ref}/Z′_{ref}.
N and T_{model_switch} are reported as part of WTRU capability.

According to embodiments, the WTRU may apply a first value for T_{model_switch} if the AIML model is one of the last used N AIML models at the WTRU and apply a second value for T_{model_switch} if the AIML model is not one of the last used AIML models. For example, the first value may be smaller than the second value. For example, the second value may be a proportional of the size of the specific AIML model, i.e., larger values for large AIML model and smaller values for small AIML model.

According to embodiments, the WTRU can reserve a variable amount of time for CSI processing depending on whether AIML (when a single model is available)/non-AIML, or Legacy/AIML model type 1/AIML model type 2 is used for CSI processing. The WTRU may indicate the required amount of time for CSI processing to the base station (e.g., gNB), which enables the WTRU to start processing the next CSI report without waiting to transmit the already processed CSI report.

Currently, “CSI processing unit (CPU)” has been introduced in NR to indicate the number of simultaneous CSI calculations supported by the WTRU. Number of CPUs (NCPU) is equal to the number of simultaneous CSI calculations supported by the WTRU. Number of CPUs occupied (OCPU) refers to the number of CPUs already occupied at the WTRU for CSI processing. The timing of the CPUs is currently fixed and is determined as follows:
For aperiodic CSI report, a CPU may start to be occupied from the first OFDM symbol after the PDCCH trigger until the last OFDM symbol of the PUSCH carrying the CSI report
For periodic and semi-persistent CSI report, a CPU may start to be occupied from the first OFDM symbol of one or more associated measurement resources (not earlier than CSI reference resource) until the last OFDM symbol of the CSI report.

A WTRU may indicate the number of supported simultaneous CSI calculations N_{CPU}, and number of simultaneous CSI reports pending R_{CPU}. A WTRU is not expected to be configured with an aperiodic CSI trigger state containing more than N_{CPU} Reporting Settings or have more than R_{CPU} pending CSI reports.

A periodic or semi-persistent CSI report (excluding an initial semi-persistent CSI report on PUSCH after the PDCCH triggering the report) may occupy CPU(s) corresponding to lesser of Zref/Z′ref and the duration from the first symbol of the earliest one of each CSI-RS/CSI-Interference Measurement (IM)/Synchronization Signal Block (SSB) resource for channel or interference measurement, respective latest CSI-RS/CSI-IM/SSB occasion no later than the corresponding CSI reference resource, until the last symbol of the configured PUSCH/PUCCH carrying the report.

An aperiodic CSI report may occupy CPU(s) corresponding to lesser of Zref/Z′ref and the duration from the first symbol after the PDCCH triggering the CSI report until ZrefAI/Z′refAI, ZrefNAI/Z′refNAI, ZrefAI1/Z′refAI1 or ZrefAI2/Z′refAI2, depending on whether AIML model, legacy (non-AI) method, AIML model of the first type or AIML model of the second type is used.

An initial semi-persistent CSI report on PUSCH after the PDCCH trigger may occupy CPU(s) corresponding to lesser of Zref/Z′ref and the duration from the first symbol after the PDCCH until ZrefAI/Z′refAI, ZrefNAI/Z′refNAI, ZrefAI1/Z′refAI1 or ZrefAI2/Z′refAI2, depending on whether AIML model, legacy (non-AI) method, AIML model of the first type or AIML model of the second type is used.

Here, Zref and Z′ref correspond to either Zₖ^{AI}/Zₖ^{NAI}/Zₖ^{AI1}/Zₖ^{AI2} and Z′ₖ^{AI}/Z′ₖ^{NAI}/Z′ₖ^{AI1}/Z′ₖ^{AI2}, where k=1, 2, 3, depending on whether AIML (when a single model is available)/non-AIML or Legacy/AIML model type 1/AIML model type 2 is used for CSI processing.

E.g., section 5.4 from 3GPP TS 38.214 (UE CSI Computation Time) describes the calculation of WTRU CSI computation time Zref/Z′ref which corresponds to either Z1/Z′1, Z2/Z′2 or Z3/Z′3, depending on the specific CSI report configuration.

The values of Zₖ/Z′ₖ, where k=1, 2, 3, may be modified based on whether AIML model, legacy (non-AI) method, AIML model of the first type or AIML model of the second type is used, and may be represented by ZkAI/Z′kAI, ZkNAI/Z′kNAI, ZkAI1/Z′kAI1 or ZkAI2/Z′kAI2, where k=1, 2, 3, respectively. These different parameters may be defined as any of the following:
(Zₖ^{AI}, Z′ₖ^{AI}), where k=1, 2, 3, when AIML is used for CSI processing.
(Zₖ^{NAI}, Z′ₖ^{NAI}), where k=1, 2, 3, when legacy method (non-AI) is used for CSI processing.
(Zₖ^{AI1}, Z′ₖ^{AI1}), where k=1, 2, 3, when a first type of AIML model is used CSI processing—for example, the first type of AIML model may be configured for low latency and/or low computational complexity CSI processing and/or for a first range of input dimension and/or output dimension.
(Zₖ^{AI2}, Z′ₖ^{AI2}), where k=1, 2, 3, when a second type of AIML model may be configured for higher compression and/or higher resolution CSI processing and/or a second range of input dimension and/or output dimension.

Table 2 corresponds to table 5.4-1 in 3GPP TS 38.214 expanded to include the different alternative values for Z1/Z′1 corresponding to the description above, and the applicable column is chosen depending on the current requirements, i.e., whether AIML model, legacy (non-AI) method, AIML model of the first type or AIML model of the second type is used. The columns labeled Z₁^{NAI}, Z′₁^{NAI} are identical to the original columns in Table 5.4-1 in 3GPP TS 38.214. Similarly, table 5.4-2 that includes CSI computation delay parameters Z1/Z′1, Z2/Z′2 and Z3/Z′3 can be extended with corresponding alternative values depending on the type of deployed CSI compression.

TABLE 2
Expanded table for CSI computation delay requirement 1

| | Z₁ [symbols] | | | | | | | |
|---|---|---|---|---|---|---|---|---|
| μ | Z₁^{NAI} | Z′₁^{NAI} | Z₁^{AI} | Z′₁^{AI} | Z₁^{AI1} | Z′₁^{AI1} | Z₁^{AI2} | Z′₁^{AI2} |
| 0 | 10 | 8 | 13 | 11 | 8 | 6 | 15 | 13 |
| 1 | 13 | 11 | 16 | 14 | 11 | 9 | 18 | 16 |
| 2 | 25 | 21 | 28 | 24 | 23 | 19 | 30 | 27 |
| 3 | 43 | 36 | 46 | 39 | 41 | 34 | 48 | 42 |

5.2.3. Implicit Determination of AIML Model Based on Content of UCI Bits (e.g., Collision with Other UCI)

The WTRU may choose between a legacy CSI reporting method and AIML method to compress the CSI report, and further between different available AIML models to compress the CSI report to varying degrees or to altogether drop the CSI report based on the number of available UCI bits. The number of available UCI bits may be limited by base station (e.g., gNB) allocation, other co-scheduled CSI reports, Acknowledgement (ACK)/Negative ACK (NACK), etc.

The WTRU may determine the compression of the CSI report depending on the available resources for UCI transmission, taking into consideration other co-scheduled CSI reports, ACK/NACK, etc.
Determination of which CSI report must be compressed may be based on the CSI type, i.e., scheduled, aperiodic, etc.
Determination of additional compression requirement or to instead drop the CSI report may be based on the UCI resource shortfall and the time available for CSI compression.

The WTRU may be configured with certain resources for UCI transmission that may include both CSI reports and HARQ-ACKs sharing the same resources. The compressed CSI reports may have associated minimum/required resolution level and also an acceptable/lower resolution. Further, the WTRU may determine that the available UCI resources are not sufficient to transmit all N requested CSI reports at the requested resolution level at the configured reporting latency T_{report_latency}, and if the WTRU is configured for low latency (e.g. either implicitly based on PUCCH resource timing or explicitly as part of CSI config) the WTRU is not required to update the N−M requested CSI reports with lowest priority, where 0≤M≤N is the largest value such that Σₙ₌₀^{M-1}(Z_{ref}^{AI1})ₘ≤T_{report_latency} holds.

The WTRU may be configured with certain resources for UCI transmission that may include both CSI reports and HARQ-ACKs sharing the same resources. The compressed CSI reports may have associated minimum/required resolution level and also an acceptable/lower resolution. Further, the WTRU may determine that the available UCI resources are not sufficient to transmit all N requested CSI reports at the requested resolution level at the configured reporting latency T_{report_latency}, and if the WTRU is configured for high resolution CSI feedback (e.g. either implicitly based on PUCCH resource timing or explicitly as part of CSI config) the WTRU is not required to update the N−M requested CSI reports with lowest priority, where 0≤M≤N is the largest value such that Σₙ₌₀^{M-1}(Z_{ref}^{AI2})ₘ≤T_{report_latency} holds.

The WTRU may be configured with certain resources for UCI transmission that may include both CSI reports and HARQ-ACKs sharing the same resources. The compressed CSI reports may have associated minimum/required resolution level and also an acceptable/lower resolution. Further, the WTRU may determine that the available UCI resources are not sufficient to transmit all N requested CSI reports at the requested resolution level at the configured reporting latency T_{report_latency}, and if the WTRU is configured to maximize the number of CSI reports, the WTRU is not required to update the N−M requested CSI reports with lowest priority, where M=X+Y . . . +Z is the largest value such that Σₓ₌₀^{X-1}(Z_{ref}^{AIx})ₓ+Σ_{y=0}^{Y-1}(Z_{ref}^{AIy})_{y}+Σ_{z=0}^{Z-1}(Z_{ref}^{AIz})_{z}≤T_{report_latency} holds.

The WTRU may be configured with certain resources for UCI transmission that may include both CSI reports and HARQ-ACKs sharing the same resources. The compressed CSI reports may have associated minimum/required resolution level and also an acceptable/lower resolution. Further, the WTRU may determine that the available UCI resources are not sufficient to transmit all N requested CSI reports at the requested resolution level at the configured reporting latency T_{report_latency}, and if the WTRU is configured to maximize the combination of both the resolution of CSI report and the number of CSI reports, the WTRU is not required to update the N−M requested CSI reports, where M=X+Y . . . +Z and the following conditions are true:

First, 0≤X≤N is the largest value such that Σₓ₌₀^{X-1}(Z_{ref}^{AIx})ₓ≤T_{report_latency} is true.

If additional CPUs are available, then 0≤Y≤N is the largest value such that Σ_{y=0}^{Y-1}(Z_{ref}^{AIy})_{y}≤T_{report_latency}−Σₓ₌₀^{X-1}O_{CPU}^{AIx}, and so on until no further reporting time is left or all the CSI processing complete whichever is earlier. According to embodiments, the WTRU may be configured to determine AI model for CSI processing based on the priority CSI reports. For example, the WTRU may be configured for AI model X for highest priority CSI reports and AI model Y for the next priority CSI reports so on, until model Z for lowest priority CSI reports.

### 5.2.4. Implicit Determination of AIML Model Based on PUCCH Resource Configuration

The WTRU may switch between AI models based on the allocated payload size for CSI reporting. Different models have different compression ratios, so (e.g., only) models with compression ratios yielding a number of bits less than or equal to the payload size should be considered.
The WTRU may determine α as the minimum allowed compression ratio based on the number of PUCCH payload bits (B).
The WTRU may select one of AI models satisfying the payload size constraint, i.e., any model I with αᵢ≤α yielding Bᵢ≤B.
The WTRU may select the AI model with αᵢ yielding the closest Bᵢ to B, and Bᵢ≤B.
In another option, the WTRU may select the AI model based on αᵢ together with the CSI report code rate to match payload size (B).
CSI report may comprise two parts. Part I contains RI, CRI, CQI and selected AI model information. The AI model information may include, for example, model ID. Part 2 may contain the actual CSI report.

### 5.2.5. AIML Model Selection Based on Physical Downlink Shared Channel (PDSCH) Performance

The WTRU may select the AI model based on the PDSCH performance as various models yield different performance based on the model design. For instance, different models have different compression capabilities which in turn results in different average BLER (number of received ACK/NACK over observed period of time).
The WTRU may switch between different models based on the observed average BLER through using a mapping between the supported AI models, compression ratio, and the associated BLER performance.
The WTRU may indicate the PDSCH performance as a model selection criterion by adding a new field in physical layer parameters under WTRU radio access capability parameters (TS 38.306-4.2.7.10). For example, CSI-AISelectPDSCH=1(0) may indicate that AI model selection based on BLER performance is activated.

### 5.2.6. AIML Model Selection Based on Selector Matrix

The WTRU may be configured with multiple AI models and their associated feature vectors. The AI models may have different characteristics due to training under different settings (e.g., SNR, channel characteristics, etc.). For example, the WTRU may be configured to use two AI models, one trained for low mobility scenarios, and another trained for high mobility scenario. According to embodiments, the WTRU may be configured with two AI models, one trained in a high SNR range, and another in a low SNR range. The associated feature vectors reflect the set of parameters used during model training.
The feature vectors may capture the channel characteristics, SNR, etc. A feature vector can be fᵢ=[Doppler (vᵢ), delay spread (τᵢ), SNR (γᵢ), average channel quality (qᵢ), BLERᵢ], for i=1, . . . , I.
The WTRU may select the model that is trained under a set of parameters that match the online measured parameters, e.g., to optimize the compression performance. For example, let S=(s₁, s₂, . . . , s_{I}) be a matrix with the associated feature vectors of different AI models. Then, based on WTRU measurements collected in vector \hat{f}, WTRU may select the model based on f(\hat{f},S).
As an example, f(\hat{f}, S) can be a dot product between \hat{f} and each feature vector in S, and the WTRU selects the model as

$${i}^{★} = {max}_{i} {\hat{f}}^{T} S .$$

### 5.3. Methods for AIML Model Indication

### 5.3.1. Methods of Indication of AIML Modes (Encoder/Decoder) for CSI Processing

The WTRU may indicate the AIML models (encoder/decoder) to be used for CSI processing using implicit signalling, explicit signalling, or a combination of both. The indication of AIML models here relates to one or several encoder/decoder pairs from full or partial predefined sets, for example based on autoencoder input/output dimensions, structures, and parameters.
According to embodiments, the terminal implicit or explicit indication may be based on using indices that relate to the full or partial predefined sets of AIML models, e.g., using model identifiers (IDs). The indication by the terminal may relate to both encoder and decoder model options, or the encoder model (e.g., only) where the selection of the appropriate decoder is handled by the network.
According to embodiments, the terminal may first be configured with one or several “anchor” AIML model sets. The terminal may utilize implicit or explicit indication to signal one or several “preferred” encoder/decoder sets based on the “anchor” configuration. This exemplary embodiment may be for implicit or explicit indication of encoder and decoder models, or the encoder model where the selection of the appropriate decoder is handled by the network.
According to embodiments, the terminal may use simple implicit or explicit up/down indicators for AIML CSI processing model indication—for example the terminal may indicate implicitly using a “1” or “0” in certain UL resource bit field or with dedicated signalling (UCI) to indicate an updated AIML model (encoder) from the “anchor” with “increased” or “decreased” capability (e.g., compression ratio). This exemplary embodiment may also hold for indication of both encoder and decoder models.
According to embodiments, the terminal may indicate implicitly or explicitly a multi-step/hybrid CSI processing approach, e.g., using CSI processing on no-precoded CSI-RS with conventional schemes (e.g., Type I) in the first step, and then using CSI processing/reporting on precoded CSI-RS with AI schemes.

### 5.3.2. Terminal Implicit Indication of AIML Models (Encoder/Decoder) for CSI Processing

The WTRU may indicate the AIML models (encoder/decoder) to be used for CSI processing using implicit signalling, based on embodiments in section 5.3 of the description. The indication of AIML models here relates to one or several encoder/decoder pairs from full or partial predefined sets, for example based on autoencoder input/output dimensions, structures, and parameters. The UL resource selection can be based on RACH, PUCCH, Sounding Reference Signal (SRS), or a combination of these.
According to embodiments, the terminal may have reserved parts within the uplink resource grid (bandwidth part) in time and frequency, hereafter called Physical Random-Access Channel (PRACH) occasions, that can be used for implicit indication of AIML models. For example, PRACH time occasions with parameter “PRACH configuration index” can be used for this purpose, but also PRACH frequency occasions (e.g., 1-8), PRACH slots, or a combination of these, may be utilized for implicit signaling. Also, it may be possible to incorporate CSI processing capability with SSB index as part of RACH.
According to embodiments, the terminal may be configured with PUCCH resource sets, where each resource set contains several PUCCH resource configurations including format and time/frequency location. Once the terminal receives a PDCCH/DCI triggering PUCCH transmission (e.g., aperiodic CSI report), the terminal may select a certain format or/and time-frequency location to implicitly indicate the choice of AIML (encoder, or both encoder/decoder) model. A variant of this exemplary embodiment can be where the terminal utilizes the spatial relation to implicitly indicate the choice of AIML model.
According to embodiments, the terminal may be configured with multiple SRS resources, the parameter structure for configuring an SRS resource contains fields which can be used to indicate AIML (encoder/decoder) models implicitly, e.g., SpatialRelationInfo.

### 5.3.3. Terminal Explicit Indication of AIML Models (Encoder/Decoder) for CSI Processing

The WTRU may indicate the AIML models (encoder/decoder) to be used for CSI processing explicitly through modified UL signaling, based on embodiments in section 5.3 of the description. The indication of AIML models here relates to one or several encoder/decoder pairs from full or partial predefined sets, for example based on autoencoder input/output dimensions, structures, and parameters. The explicit signaling can be based on modified UCI (using PUCCH, or PUSCH, or both).
According to embodiments, the WTRU may be configured with UCI resources (e.g., PUCCH resources with specific format differing in # of bits, # of symbols, # resource blocks with different capabilities) to transmit CSI, as where the trigger payload includes explicit signaling of full or partial AIML models (encoder/decoder) for CSI processing. This exemplary embodiment may also hold for explicit indication of encoder model (e.g., only), with the selection of the appropriate decoder handled by the network.
According to embodiments, the WTRU may utilize the dedicated PUCCH configuration resource sets with different capabilities to separate the signaling of AIML model for CSI processing and the actual reporting of CSI, e.g., the terminal may be configured with a PUCCH resource set which can handle the AIML model for CSI processing indication (1-2 bits, using formats 0, 1) and one or several PUCCH resources sets to transmit CSI.

### 6. Exemplary Embodiments

According to embodiments, the following aspects may be addressed:
Methods to determine the WTRU AIML capability with regards to CSI processing and configuration aspects related to CSI processing using AIML.
Methods to determine the type of AIML applied to CSI processing, if any, and coexistence with legacy CSI processing.
Methods to leverage flexibility and/or adapt (dynamically or by reconfiguration) of AIML processing to tradeoff CSI performance (e.g., latency, overhead and accuracy).
Methods to keep the AIML models and operation at the WTRU and the base station (e.g., gNB) coherent with each other.

According to embodiments, the UE may determine its AIML capability with regards to CSI processing:
a. The WTRU may be configured to determine its AIML capability via one or more parameters related to CSI processing.
   i. E.g., N_{CPU}, O_{CPU}, Z_{ref}, Z′_{ref}, Zₖ, Z′ₖ, etc.
   ii. Different from the baseline, the value of N_{CPU}, O_{CPU}, Z_{ref}, Z′_{ref}, Zₖ, Z′ₖ may vary as a function of
      1. Whether AIML models are used for CSI processing
      2. How many AIML models are used for CSI processing
      3. What AIML models are used for CSI processing
b. The WTRU may be configured with information related to AIML model pairing—e.g., logical identity associated with a set of encoder AIML models. A subset of encoder models may, for example, be based on a base station (e.g., gNB) indication (e.g., broadcast).

### UE Capability-Based Configuration

According to embodiments, the WTRU may transmit, e.g., as part of the WTRU capability information exchange and/or as part of the RRC Connection Establishment procedure or resume procedure, information related to one or more AIML capability parameters e.g., including:
a. WTRU capabilities determined for AI/ML.
   i. For example, aspect related to hardware capabilities—total available processing for CSI computation, or individually per CSI process
   ii. For example, aspects related to model adaptation:
      1. Minimum time for model adaptation, e.g., inference interruption time
      2. Maximum number of model adaptation and/or changes during a given period (e.g., time window)
   iii. For example, aspects related to model architecture
      1. Maximum size, layers, input/output dimensions of active model e.g., for CSI processing
      2. Maximum number of models e.g., for CSI processing
   iv. For example, aspects related to Inference
      1. Maximum inference rate
      2. Minimum time between two consecutive inferences
   v. For example, aspects related to AIML execution environment at the WTRU
b. An indication of AIML model pairing.
c. The WTRU may support MAC CE signaling to dynamically indicate its AIML capabilities and/or a change thereof e.g., when in RRC Connected state.

According to embodiments, the WTRU may receive a CSI configuration including at least one of the following:
a. An implicit/explicit configuration of applicable AIML models/parameterization etc.
b. A confirmation of AIML model pairing—an implicit indication of set of decoder AIML models. For example, the WTRU may receive via MAC CE activation/deactivation of subset of encoder models for CSI processing.

### WTRU Capability-Based Configuration OR RRC Reconfiguration+Reconfiguration Failure (Static Capabilities)

According to embodiments, the WTRU may process, validate and/or reconfigure its AIML processing using the received configuration information.
a. The WTRU may determine that it cannot comply with the reconfiguration
b. The WTRU may initiate the transmissions of a reconfiguration failure indication, potentially including the cause and/or component of the reconfiguration failure, for example, “AIML”, “capability exceeded for parameter X” or the like.
c. The WTRU may revert to the previous configuration
   i. For example, the AIML processing may be subject to the reconfiguration signaling.
   ii. For example, for the parameters subject to, and modified by, the reconfiguration signaling.

According to embodiments, the WTRU may determine:
a. Any of the following:
   i. The type of AIML processing to apply for CSI processing, if any (e.g., no AIML and/or only legacy processing, hybrid legacy+AIML processing, only AIML processing).
   ii. The AIML model(s) to use for CSI report generation.
   iii. The CSI reports to transmit.
   iv. The number of CSI reports to transmit.
b. Based on one or more preconfigured rules, for example,
   i. Determine the applicable AIML model(s), given on the maximum number of simultaneous CSI processing applicable at a given time, the WTRU configured to meet one or more of the following:
      1. criteria to maximize the number of CSI reports.
      2. criteria to maximize the resolution of all CSI reports.
      3. criteria to first maximize the resolution and/or accuracy of high priority CSI reports and then if any bits/processing capability are left then maximize the number of low priority CSI reports.
   ii. Determine applicable AIML model(s) based on the CSI report timing (e.g., latency) and availability of UL resource (e.g., payload size).
   iii. Determine the applicable AIML model(s) based on AIML model performance (e.g., may correspond to CSI reporting accuracy=>subsequently impacting PDSCH performance).

According to embodiments, the WTRU may generate one or more CSI or parts thereof based on determined AIML model(s) and transmit the CSI report using transmission resources on PUCCH, PUSCH or the like.

According to embodiments, the WTRU may transmit (either implicitly or explicitly) an indication of the AIML model used to generate the CSI report to the NW. This may be applicable at least for the cases where the model selection rules are based on information available at the WTRU:
a. For example, implicitly using uplink PUCCH resource selection (time/frequency), Demodulation Reference Signal (DMRS) scrambling, DMRS ports, PUCCH format, Cyclic Redundancy Check (CRC) selected and/or applied to the PUCCH format, etc.
b. For example, explicitly using bits in the UCI (e.g., part:1 CSI carries indication of AIML model used for encoding and part:2 CSI carries the payload).

### NW Method as Enabler

According to embodiments, the base station (e.g., gNB) may detect a transmission on one or a plurality of configured PUCCH resource; in one method, the base station (e.g., gNB) may further determine what AIML model was used to generate the CSI information (or what model to use to decode the received information) within the PUCCH transmission as a function the identity of the resource. In one method, the base station (e.g., gNB) may perform blind decoding for the PUCCH transmission and further determine what AIML model was used to generate the CSI information (or what model to use to decode the received information) within the PUCCH transmission as a function of the CRC used to successfully decode the received information.

### Details of Preconfigured Rules

According to embodiments, a rule to maximize number of CSI reports may include, for example:
a. The WTRU determines the AIML models for CSI processing to maximize the number of CSI reports given the number of N_{CPU}−L CPUs are unoccupied.
b. If L CPUs are occupied for calculation of CSI reports in a given OFDM symbol, the WTRU has N_{CPU}−L unoccupied CPUs. If N CSI reports start occupying their respective CPUs on the same OFDM symbol on which N_{CPU}−L CPUs are unoccupied, and if the WTRU is configured to maximise the number of CSI reports the WTRU is not required to update the N−M requested CSI reports where M=X+Y . . . +Z is the largest value such that Σₓ₌₀^{X-1}O_{CPU}^{AIx}+Σ_{y=0}^{Y-1}O_{CPU}^{AIy} . . . +Σ_{z=0}^{Z-1}O_{CPU}^{AIz}≤N_{CPU}−L holds.

According to embodiments, a rule to Maximize resolution of CSI reports may include, for example, if L CPUs are occupied for calculation of CSI reports in a given OFDM symbol, the WTRU has N_{CPU}−L unoccupied CPUs. If N CSI reports start occupying their respective CPUs on the same OFDM symbol on which N_{CPU}−L CPUs are unoccupied, and if the WTRU is configured to maximise the combination of both the resolution of CSI report and the number of CSI reports, the WTRU is not required to update the N−M requested CSI reports where M=X+Y . . . +Z and the following conditions are true: First, 0≤X≤N is the largest value such that Σₓ₌₀^{X-1}O_{CPU}^{AIx}≤N_{CPU}−L is true. If additional CPUs left, then 0≤Y≤N is the largest value such that Σ_{y=0}^{Y-1}O_{CPU}^{AIy}≤N_{CPU}−L−Σₓ₌₀^{X-1}O_{CPU}^{AIx} and so on until no CPUs left or all the CSI processing complete whichever is earlier.

According to embodiments, a rule based on relative prioritization of CSI reports may include, for example:
a. Different AIML models may be associated with different CSI report priorities.
b. Prioritizing high resolution CSI for high priority CSI reports.
c. A collision between two or more CSI reports:
   i. AIML model determines which CSI report to drop; and/or
   ii. The WTRU chooses AIML model adjust the resolution to accommodate plurality of CSI reports.

According to embodiments, rules based on AIML model performance may include, for example:
a. A WTRU configured with plurality of AI models and an associated selector matrix S, where S is of dimension N_{f}×Nₘ, N_{f}=feature dimension (e.g., characterizing model performance (e.g. Normalized Mean Square Error (NMSE), cosine similarity etc.), channel characteristics (e.g. SNR range, Doppler range etc.), PDSCH performance (BLER, ACK/NACK etc.) Nm=number of AIML models configured/activated.
b. A WTRU that determines the AIML Model i* for CSI processing based on the following criteria:
   i.

$${i}^{★} = {max}_{i} {\hat{f}}^{T} S .$$

ii. Where \hat{f} is the estimated feature vector.

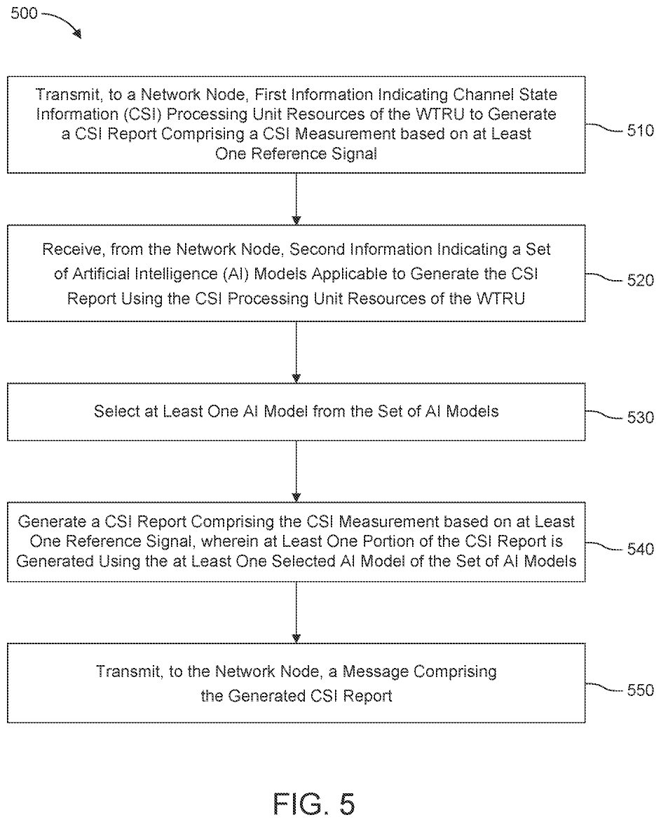

FIG. 5 is a flowchart illustrating a representative method implemented by a WTRU 102.

Referring to FIG. 5, the representative method 500 may include, at block 510, transmitting, to a network node, first information indicating CSI processing unit resources of the WTRU to generate a CSI report comprising a CSI measurement based on at least one reference signal. At block 520, the WTRU may receive, from the network node, second information indicating a set of artificial intelligence (AI) models applicable to generate the CSI report using the CSI processing unit resources of the WTRU. At block 530, the WTRU may select at least one AI model from the set of AI models. At block 540, the WTRU may generate a CSI report comprising the CSI measurement based on at least one reference signal, wherein at least one portion of the CSI report is generated using the at least one selected AI model of the set of AI models. At block 550, the WTRU may transmit, to the network node, a message comprising the generated CSI report.

In certain representative embodiments, the method 500 may further comprise generating, using codebook-based precoding and using the CSI measurement based on at least one reference signal, at least one further portion of the CSI report.

In certain representative embodiments, the method 500 may further comprise transmitting third information indicating the at least one selected AI model.

In certain representative embodiments, the first information may indicate any of: (1) a maximum number of CSI processing units available at the WTRU to process the CSI, (2) a maximum number of AI models to process the CSI, and (3) a CSI computation time.

In certain representative embodiments, each AI model of the set of AI models is associated with a number of CSI processing units used to process the CSI.

In certain representative embodiments, the method 500 may further comprise receiving, from the network node, a CSI reporting configuration and/or the CSI reporting configuration may indicate to generate the at least one portion of the CSI report, for example, using at least one AI model of the set of AI models.

In certain representative embodiments, the at least one portion of the CSI report is determined based on any of: (1) an AI model configuration, (2) a codebook configuration, (3) a CSI resource configuration, (4) a CSI reference signal resource configuration, and (5) a maximum number of CSI processing units available at the WTRU to process the CSI.

In certain representative embodiments, the at least one AI model is one AI model and the one AI model may correspond to an encoder AI model comprising an encoder function, and wherein the one AI model is associated to a corresponding decoder AI model comprising a decoder function.

In certain representative embodiments, generating the at least one portion of the CSI report may comprise encoding the at least one portion of the CSI report using the encoder function of the encoder AI model.

In certain representative embodiments, the at least one AI model may be selected, by the WTRU, from a set of configured AI models.

In certain representative embodiments, the at least one AI model may be selected from the set of AI models based on any of: (1) an indication of a type of AI processing, (2) an indication of a type of the CSI report to transmit, (3) an indication of an AI model, (4) an indication of a number of CSI reports to transmit, (5) an indication of CSI report timing, (6) an indication of an availability of an uplink resource, and/or (7) an indication of an AI model performance.

In certain representative embodiments, the method 500 may further comprise generating the CSI report using the CSI processing unit resources.

In certain representative embodiments, the WTRU may be configured with a plurality of AIML models wherein each AIML model may be associated with a different inference latency. Upon receiving aperiodic CSI request, the WTRU may identify the subset AIML model(s) whose inference latency meets the time domain resource allocation deadline and selects the AIML model that generates maximum CSI resolution (by default) or maximum number of CSI reports—(if indicated by aperiodic req).

In certain representative embodiments, the WTRU may be configured with a plurality of AIML models wherein each AIML model may be associated with the feature vector—feature vector may include a characteristic of dataset used to training the model, performance metric of the model etc. The WTRU may select the AIML model with associated feature vector which maximizes the dot product between measurement vector and feature vector.

In certain representative embodiments, the WTRU may be configured with a plurality of AIML models wherein each AIML model may be associated with a different compression ratio. For example, upon receiving aperiodic CSI request, the WTRU may identify the subset AIML model(s) based on the number of UCI payload bits allocated and number of CSI reports triggered.

In certain representative embodiments, the method 500 may further comprise pairing based on a combination of decoder-based down selection (set of encoder models based on gNB indication of available decoder models) and encoder-based pairing (WTRU selecting encoder(s) based on preconfigured rules and WTRU capability), and/or indicating AIML model pairing, for example, during initial access procedure (RA resource selection or the likes), wherein the validity of the pairing may be UE specific or cell specific.

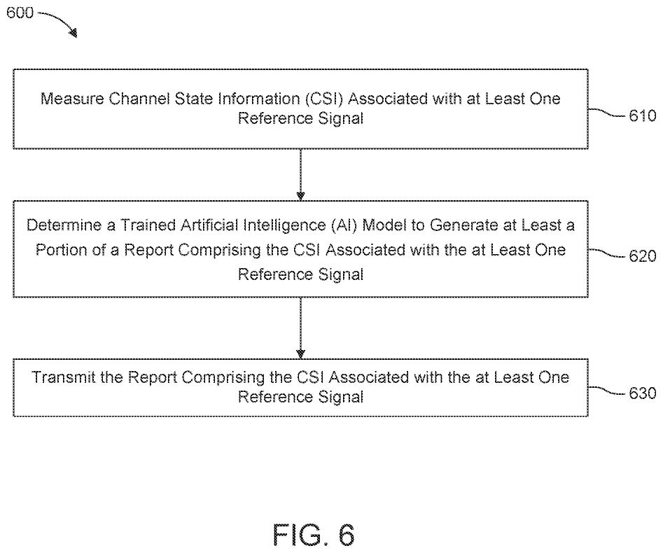

FIG. 6 is a flowchart illustrating a representative method implemented by a WTRU 102.

Referring to FIG. 6, the representative method 600 may include, at block 610, measuring Channel State Information (CSI) associated with at least one reference signal. At block 620, the WTRU may determine a trained Artificial Intelligence (AI) model to generate at least a portion of a report comprising the CSI associated with the at least one reference signal. At block 630, the WTRU may transmit the report comprising the CSI associated with the at least one reference signal.

In certain representative embodiments, the AI model may correspond to an encoder AI model comprising an encoder function, and/or wherein the AI model is associated to a corresponding decoder AIML model comprising a decoder function.

In certain representative embodiments, generating the at least portion of the report may comprise encoding the at least portion by the encoder function of the encoder AI model.

In certain representative embodiments, the method 600 may further comprise transmitting, to a network node, information indicating the determined trained AI model.

In certain representative embodiments, the network node is a base station.

In certain representative embodiments, the method 600 may further comprise generating a further portion of the report comprising the CSI, using a precoding matrix.

In certain representative embodiments, the AI model is selected from a set of trained AI model.

In certain representative embodiments, the AI model is selected from the set of trained AI model based on any of: (1) an indication of a type of AI processing, (2) an indication of the CSI report to transmit, (3) an indication of an AI model, and/or (4) an indication of a number of CSI reports to transmit.

In certain representative embodiments, the AI model is selected from the set of trained AI model based on at least a preconfigured rule based on any of: (1) an indication of a number of CSI reports, (2) an indication of resolution of CSI report, (3) an indication of CSI report timing, (4) an indication of an availability of uplink resource, and/or (5) an indication of a AIML model performance.

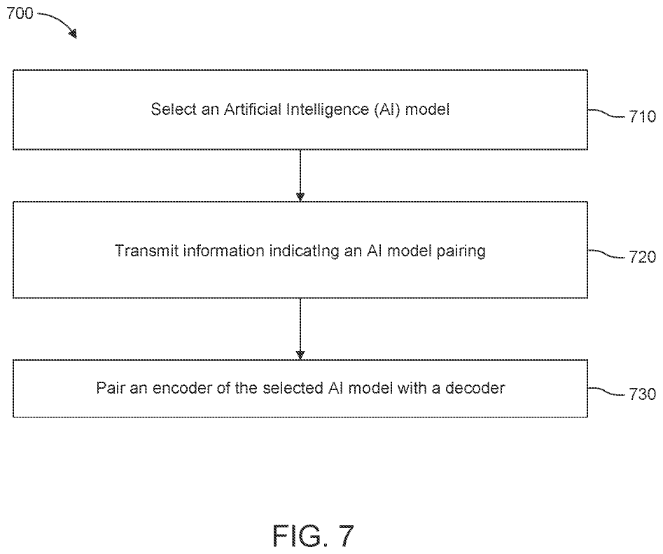

FIG. 7 is a flowchart illustrating a representative method of pairing implemented by a WTRU 102.

Referring to FIG. 7, the representative method 700 may include, at block 710, selecting an AI model. At block 720 to 730, the WTRU may further comprise pairing based on a combination of decoder-based down selection (set of encoder models based on gNB indication of available decoder models) and encoder-based pairing (WTRU selecting encoder(s) based on preconfigured rules and WTRU capability), and/or indicating AIML model pairing, for example, during initial access procedure (RA resource selection or the likes), wherein the validity of the pairing may be UE specific or cell specific.

### CONCLUSION

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

1. A method implemented by a wireless transmit/receive unit (WTRU), the method comprising:
transmitting, to a network node, first information indicating channel state information (CSI) processing unit resources of the WTRU to generate a CSI report;
receiving, from the network node, second information indicating a set of artificial intelligence (AI) models applicable to generate the CSI report using the CSI processing unit resources of the WTRU;
selecting at least one AI model from the set of AI models;
generating the CSI report, wherein the CSI report comprises a CSI measurement based on at least one reference signal, wherein a first portion of the CSI report is generated using the at least one selected AI model of the set of AI models, and wherein a second portion of the CSI report is generated, based on a measurement quantity using the CSI measurement; and
transmitting, to the network node, a message comprising the generated CSI report.

2. (canceled)

3. The method according to claim 1, further comprising:
transmitting third information indicating the at least one selected AI model.

4. The method according to claim 1, wherein the first information indicates any of: (1) a maximum number of CSI processing units available at the WTRU to process the CSI, (2) a maximum number of AI models to process the CSI, and (3) a CSI computation time.

5. The method according to claim 1, wherein each AI model of the set of AI models is associated with a number of CSI processing units used to process the CSI.

6. The method according to claim 1, further comprising:
receiving, from the network node, a CSI reporting configuration, wherein the CSI reporting configuration indicates to generate the first portion of the CSI report using at least one AI model of the set of AI models.

7. The method according to claim 1, wherein the first portion of the CSI report is determined based on any of: (1) an AI model configuration, (2) a codebook configuration, (3) a CSI resource configuration, (4) a CSI reference signal resource configuration, and (5) a maximum number of CSI processing units available at the WTRU to process the CSI.

8. The method according to claim 1, wherein the at least one AI model is one AI model, wherein the one AI model corresponds to an encoder AI model comprising an encoder function, and wherein the one AI model is associated to a corresponding decoder AI model comprising a decoder function.

9. The method according to claim 1, wherein generating the first portion of the CSI report comprises encoding the first portion of the CSI report using the encoder function of the encoder AI model.

10. (canceled)

11. The method according to claim 1, wherein the at least one AI model is selected from the set of AI models based on any of: (1) an indication of a type of AI processing, (2) an indication of a type of the CSI report to transmit, (3) an indication of an AI model, (4) an indication of a number of CSI reports to transmit, (4) an indication of CSI report timing, (5) an indication of an availability of an uplink resource, and (6) an indication of an AI model performance.

12. The method according to claim 1, further comprising generating the CSI report using the CSI processing unit resources.

13. A wireless transmit/receive unit (WTRU) comprising a processor and a transmit/receive unit configured to:
transmit, to a network node, first information indicating channel state information (CSI) processing unit resources of the WTRU to generate a CSI report;
receive, from the network node, second information indicating a set of artificial intelligence (AI) models applicable to generate the CSI report using the CSI processing unit resources of the WTRU;
select at least one AI model from the set of AI models;
generate the CSI report, wherein the CSI report comprises a CSI measurement based on at least one reference signal, wherein a first portion of the CSI report is generated using the at least one selected AI model of the set of AI models, and wherein a second portion of the CSI report is generated, based on a measurement quantity using the CSI measurement; and
transmit, to the network node, a message comprising the generated CSI report.

14. (canceled)

15. The WTRU according to claim 13, wherein the transmit/receive unit is further configured to:
transmit third information indicating the at least one selected AI model.

16. The WTRU according to claim 13, wherein the first information indicates any of: (1) a maximum number of CSI processing units available at the WTRU to process the CSI, (2) a maximum number of AI models to process the CSI, and (3) a CSI computation time.

17. The WTRU according to claim 13, wherein each AI model of the set of AI models is associated with a number of CSI processing units used to process the CSI.

18. The WTRU according to claim 13, wherein the transmit/receive unit is further configured to:
receive from the network node, a CSI reporting configuration, and wherein the CSI reporting configuration indicates to generate the at least one portion of the CSI report using at least one AI model of the set of AI models.

19. The WTRU according to claim 13, wherein the at least one portion of the CSI report is determined based on any of: (1) an AI model configuration, (2) a codebook configuration, (3) a CSI resource configuration, (4) a CSI reference signal resource configuration, and (5) a maximum number of CSI processing units available at the WTRU to process the CSI.

20. The WTRU according to claim 13, wherein the at least one AI model is one AI model, wherein the one AI model corresponds to an encoder AI model comprising an encoder function, and wherein the one AI model is associated to a corresponding decoder AI model comprising a decoder function.

21. The WTRU according to claim 13, wherein the generation of the at least one portion of the CSI report comprises encoding the at least one portion of the CSI report using the encoder function of the encoder AI model.

22. (canceled)

23. The WTRU according to claim 13, wherein the at least one AI model is selected from the set of AI models based on any of: (1) an indication of a type of AI processing, (2) an indication of a type of the CSI report to transmit, (3) an indication of an AI model, (4) an indication of a number of CSI reports to transmit, (4) an indication of CSI report timing, (5) an indication of an availability of an uplink resource, and (6) an indication of an AI model performance.

24. The WTRU according to claim 13, wherein the processor is further configured to:
generate the CSI report using the CSI processing unit resources.
